(19) United States
(12) Patent Application Publication
(10) Pub. No.: US 2008/0249774 A1
(43) Pub. Date: Oct. 9, 2008

(54) METHOD AND APPARATUS FOR SPEECH SPEAKER RECOGNITION

(75) Inventors: Hyun-Soo KIM, Yongin-si (KR); Myeong-gi Jeong, Bupyeong-gu (KR); Hyun-Sik Shim, Yongin-si (KR); Young-Hee Park, Seoul (KR); Ha-Jin Yoo, Seoul (KR); Guen-Chang Kwak, Seo-gu (KR); Hye-Jin Kim, Yuseong-gu (KR); Kyung-Sook Bae, Yuseong-gu (KR)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si (KR); ELECTRONICS AND TELECOMMUNICATIONS RESEARCH INSTITUTE, Yuseong-gu (KR)

(21) Appl. No.: 12/061,156

(22) Filed: Apr. 2, 2008

(30) Foreign Application Priority Data
Apr. 3, 2007 (KR) 2007-0032988

(51) Int. Cl. G10L 17/00

(52) U.S. Cl. 704/250; 704/246; 704/E17.005

(57) ABSTRACT

Disclosed is a method for speech speaker recognition of a speech speaker recognition apparatus, the method including detecting effective speech data from input speech; extracting an acoustic feature from the speech data; generating an acoustic feature transformation matrix from the speech data according to each of Principal Component Analysis (PCA) and Linear Discriminant Analysis (LDA), mixing each of the acoustic feature transformation matrixes to construct a hybrid acoustic feature transformation matrix, and multiplying the matrix representing the acoustic feature with the hybrid acoustic feature transformation matrix to generate a final feature vector; and generating a speaker model from the final feature vector, comparing a pre-stored universal speaker model with the generated speaker model to identify the speaker, and verifying the identified speaker.

### PRIORITY

This application claims priority under 35 U.S.C. §119(a) to an application entitled “Method and Apparatus for Speech Speaker Recognition” filed in the Korean Industrial Property Office on Apr. 3, 2007 and assigned Serial No. 2007-0032988, the contents of which are incorporated herein by reference.

### BACKGROUND OF THE INVENTION

1. Field of the Invention

The present invention relates generally to speech processing, and in particular, to a method and an apparatus for speech speaker recognition.

2. Description of the Related Art

Technologies drawing attention in a network-based intelligent robot system include a Human-Robot Interaction (HRI) technology. The HRI technology is a technology for smooth interaction between a robot and a human by using image information obtained by a camera of the robot, speech information obtained by a microphone of the robot, and sensor information of the robot obtained by other sensors. Since a user recognition technology allows a robot to recognize a particular user, the user recognition technology is an essential factor for the HRI technologies. The user recognition technology is broadly classified into face recognition technologies for recognizing a user's face and speaker recognition technologies for recognizing a speaker who is speaking by using speech information of the speaker. In a robot environment, research is being conducted for face recognition technologies and speech recognition technologies, whereas research on speaker recognition technologies have remained rudimentary. Current speaker recognition in the field of biometric recognition is possible in a tranquil environment, and is usually performed in an optimal environment maintaining a predetermined distance. However, a robot environment requires a speaker recognition technology robust against all noise occurring due to the robot moving or against a noise environment surrounding a robot. In addition, it is difficult to correctly recognize and identify a speaker, because the speaker may not always speak while keeping a given distance from a robot, or the speaker may speak in any direction around a robot. Moreover, most biometric recognition technologies used for security include a text-dependent style, which employs speaking a specific text, or a text-prompt style, which employs prompting a certain text. However, a robot must perform speaker recognition through a text-independent style because a user may command the robot to perform various instructions. The text-independent speaker recognition is classified into Speaker Identification (SI) or Speaker Verification (SV).

To perform a speaker recognition technology in a network-based intelligent robot environment, it is necessary to register a speaker in real time through network transmission of an on-line environment. A step of speaker verification is indispensable after the text-independent speaker identification for recognizing who is speaking or if a speaker is a registrant or a non-registrant from voice input when a speaker commands a robot to interact or to perform an action. Furthermore, to reflect time-varying characteristics, it is necessary to employ a speaker identification scheme for performing extraction of a noise-resistant feature in a robot environment in addition to a method for adapting speech data for a registered speaker.

### SUMMARY OF THE INVENTION

The present invention has been made to solve the above-mentioned problems, and the present invention provides a method and an apparatus for speaker recognition, which can achieve an accurate speaker identification.

The present invention also provides a method and an apparatus for speaker recognition robust against a noise environment.

In accordance with an aspect of the present invention, a method for speech speaker recognition of a speech speaker recognition apparatus is provided. The method includes detecting effective speech data from input speech; extracting an acoustic feature from the speech data; generating an acoustic feature transformation matrix from the speech data according to each of Principal Component Analysis (PCA) and Linear Discriminant Analysis (LDA); mixing each of the acoustic feature transformation matrixes to construct a hybrid acoustic feature transformation matrix; multiplying the matrix representing the acoustic feature with the hybrid acoustic feature transformation matrix to generate a final feature vector; generating a speaker model from the final feature vector; comparing a pre-stored universal speaker model with the generated speaker model to identify the speaker; and verifying the identified speaker.

In accordance with another aspect of the present invention, an apparatus for speech speaker recognition is provided. The apparatus for speech speaker recognition includes a speech detection unit for detecting effective speech data from input speech; a feature extraction unit for extracting an acoustic feature from the speech data; a feature transformation unit for generating an acoustic feature transformation matrix from the speech data according to each of the PCA and the LDA, mixing each of the acoustic feature transformation matrixes to construct a hybrid acoustic feature transformation matrix, and multiplying the matrix representing the acoustic feature with the hybrid acoustic feature transformation matrix to generate a final feature vector; and a recognition unit for generating a speaker model from the final feature vector, comparing a pre-stored general speaker model with the generated speaker model to identify the speaker, and verifying the identified speaker.

It is preferred that the hybrid acoustic feature transformation matrix has a dimensionality equal to a dimensionality of each of the PCA acoustic feature transformation matrix and the LDA acoustic feature transformation matrix.

### BRIEF DESCRIPTION OF THE DRAWINGS

The above and other objects, aspects, features and advantages of the present invention will become more apparent from the following detailed description when taken in conjunction with the accompanying drawings, in which:

FIG. 1 is a diagram illustrating a network-based intelligent robot system according to the present invention;

FIG. 2 is a diagram illustrating a process for user speech registration according to the present invention;

FIG. 3 is a block diagram illustrating a construction of a speech speaker recognition apparatus of a robot server according to the present invention;

FIG. 4 is a flow chart illustrating a process for speech speaker recognition according to the present invention; and

FIG. 5 is a diagram illustrating a process for acoustic feature transformation according to the present invention.

### DETAILED DESCRIPTION OF THE EXEMPLARY EMBODIMENT

Hereinafter, an exemplary embodiment of the present invention will be described with reference to the accompanying drawings. In the following description, a detailed description of known functions and configurations incorporated herein will be omitted when it may make the subject matter of the present invention rather unclear.

The present invention provides a method and an apparatus, which can achieve accurate speaker recognition through noise-resistant acoustic feature transformation of speech data for speaker recognition processing using voice. Although the speaker recognition can be applied to all kinds of systems including security-related systems as well as robot systems or different systems using a voice instruction, one embodiment of the present invention described is an example of applying speaker recognition to a robot system.

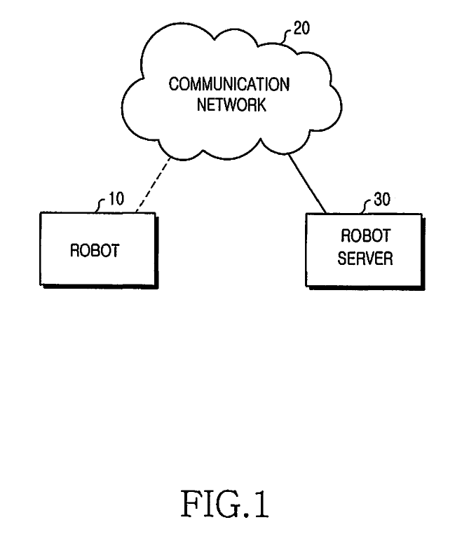

A construction of a network-based intelligent robot system employing one embodiment of the present invention will be described with reference to FIG. 1. The network-based intelligent robot system includes a robot 10 and a robot server 30, and they may interconnect through a communication network 20.

The communication network 20 may be one communication network among a variety of existing wired/wireless communication networks. For example, a TCP/IP based wired/wireless network may include Internet, a wireless Local Area Network (LAN), a mobile communication network (e.g. CDMA, GSM), and a Near Field communication related network, which plays a role of a data communication path between the robot 10 and the robot server 30.

The robot 10 may include all kinds of intelligent robots, and it recognizes a surrounding environment by using image information obtained by a camera, speech information obtained by a microphone of a robot, sensor information obtained by other sensors of a robot, e.g. distance sensor, and performs predetermined actions. The robot also performs actions corresponding to action instructions included in speech information, which is received through a communication network 20 or results from a microphone. To this end, the robot 10 includes a variety of driving motors and controls devices so as to perform the actions. In addition, the robot 10 includes a speech detection unit (not shown) according to one embodiment of the present invention, and detects an acoustic feature from speech signals input through a microphone by using an Endpoint Detection Algorithm for Speech Signal, a Zero-Crossing Rate, and energy, so that the speech is suitable for the robot 10 (i.e. a client). Then, the robot 10 transmits the speech data including the detected acoustic features to the robot server 30 through the communication network 20. In this case, the robot 10 may transmit the speech data in a streaming scheme.

The robot server 30 transmits instructions for the control of the robot 10 to the robot 10 or provides information regarding the update of the robot 10 to the robot 10. Then, the robot server 30 provides a speaker recognition service in relation to the robot 10 according to one embodiment of the present invention. Therefore, the robot server 30 including a speaker recognition apparatus 40 constructs a database necessary for the speaker recognition, and processes speech data received from the robot 10, thereby providing a speaker recognition service. That is, the robot server 30 extracts an acoustic feature from the speech data that the robot 10 transmits according to the streaming scheme, and performs feature transformation. Then, the robot server 30 generates a speaker model to compare with speaker models registered in advance, identifies a specific speaker according to the comparison, performs speaker recognition through verification of the speaker, and reports the result thereof to the robot 10.

To perform speaker identification and speaker verification as described above, it is inevitable to previously register speech of a speaker, who is to be registered, on offline or online. However, under a robot environment, it is important to perform online registration in real time, because the environment in which the speech registration is performed has a large influence on the performance of speaker identification and speaker verification. Since it takes a long time to register many texts during online speaker registration, it is inevitable to previously construct a universal background speaker model. The speech adaptation is performed by using several texts from this model and then an online speaker is registered. Moreover, since this universal background speaker model has a variety of tone information from many people, it is valuably used in a speaker verification step. The adaptation method employs widely used Maximum A Posteriori (MAP).

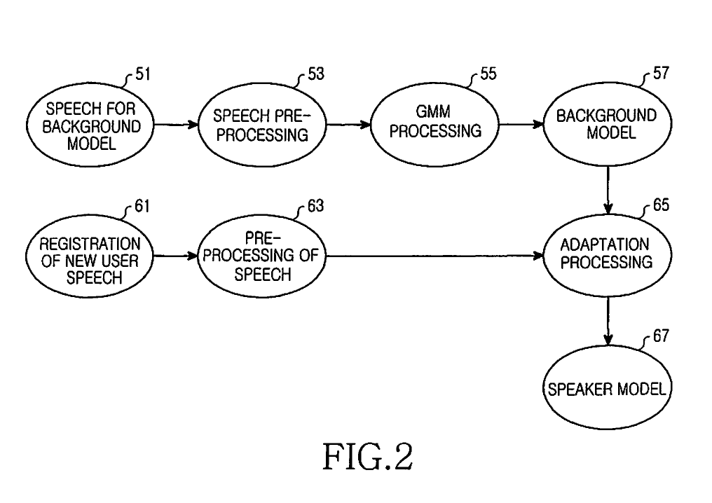

The above-described registration process is shown in FIG. 2. FIG. 2 is a diagram illustrating a process for user speech registration according to the present invention. When speech for a background model is an input in step 51, the robot server 30 performs speech pre-processing in step 53. In step 55, the robot server 30 generates a model of the pre-processed speech according to the Gaussian Mixture Model (GMM). In step 57, it registers the modeled speech as a background speaker model. When new user speech instead of speech for a background model is input in step 61, the robot server 30 performs the pre-processing of the speech in step 63. The robot server 30 consults background speaker models in step 65 to perform adaptation processing, and generates a speaker model in step 67.

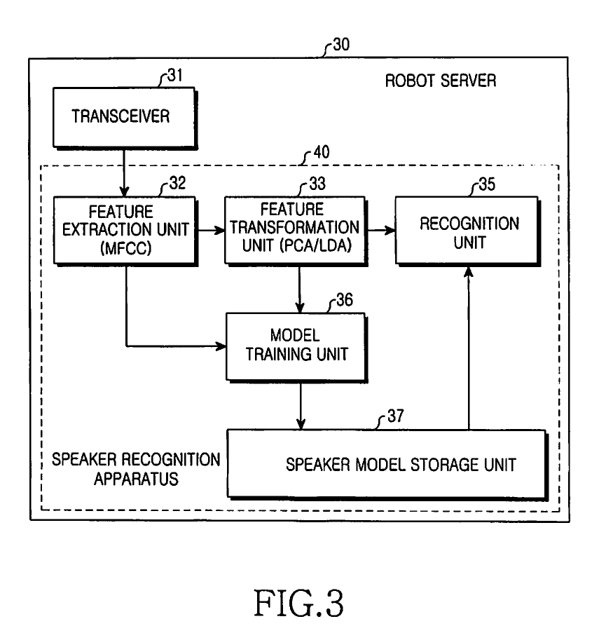

A construction of the above-described robot server 30 according to the present invention is shown in FIG. 3. The robot server 30 includes a transceiver 31, and a speaker recognition apparatus 40 including a feature extraction unit 32, a feature transformation unit 33, a recognition unit 35, a model training unit 36, and a speaker model storage unit 37.

The transceiver 31 receives speech data from the robot 10, and outputs the received speech data to the feature extraction unit 32 of the speaker recognition apparatus 40.

The feature extraction unit 32 extracts an acoustic feature from the speech data of a speaker, and it extracts a Mel Frequency Cepstrum Coefficient (MFCC), which is an acoustic feature value.

The feature transformation unit 33 transforms acoustic features by using Principal Component Analysis (PCA) and Linear Discriminant Analysis (LDA), and generates a hybrid acoustic feature transformation matrix by combining in parallel an acoustic feature transformation matrix representing acoustic features transformed according to the PCA with and an acoustic feature transformation matrix representing acoustic features transformed according to the LDA. Then, the MFCC extracted from the feature extraction unit 32 is multiplied to the hybrid acoustic feature transformation matrix so as to generate a finally transformed acoustic feature vector. In such an acoustic feature transformation process, it is possible to extract noise-resistant acoustic features, which results in the improvement of the speaker recognition performance. The PCA is mainly used to lessen storage capacity and processing time by constructing a mutual independent axis and reducing dimensionality for a specific space representation. Moreover, the PCA reduces dimensionality of an acoustic feature of speech recognition or speaker recognition, eliminates unnecessary information and lessens a model size or recognition time. The process for acoustic feature transformation according to the PCA will now be described.

Step 1: A mean value of each dimension is subtracted from elements of each dimension of all speech data, so that the mean value of each dimension becomes zero.

Step 2: A covariance matrix is calculated by using training data. The covariance matrix represents correlation and variation of a feature vector.

Step 3: An eigenvector of a covariance matrix A is calculated. When the covariance matrix A is an n×n matrix, x represents a row vector of an n dimension, and λ corresponds to a real number, which is expressed as Equation (1) below.

Ax=λx (1)

In Equation (1), λ denotes an eigenvalue and x denotes an eigenvector. Since there are so many eigenvectors corresponding to specific eigenvalues, a unit eigenvector is generally used.

Step 4: An acoustic feature transformation matrix is constructed by collecting the calculated eigenvectors. The direction of the eigenvector corresponding to the largest eigenvalue becomes the most significant axis representing the distribution of all speech data, whereas the direction of the eigenvector corresponding to the smallest eigenvalue becomes the least significant axis. Therefore, an acoustic feature transformation matrix is constructed by using several axes having the largest eigenvalue. However, the speaker recognition uses all axes because the dimensions are not so large.

The above-described PCA is a scheme for data reduction in the aspect of optimal representation of data, whereas the LDA is a scheme for data reduction in the aspect of optimal classification of data. The LDA aims to maximize ratios between classes and within classes. When a scatter matrix within classes is named S_{w} and a scatter matrix between classes is named S_{B}, it is possible to calculate a transformation matrix W* that maximizes an objective function, as shown in Equation (2) below.

$${W}^{*} = arg max \{ \frac{{w}^{T} {S}_{B} w}{{w}^{T} {S}_{w} w} \} \qquad ( 2 )$$

The PCA is a scheme for eliminating correlation, and transforming data so as to well represent its feature, and the LDA is a scheme for transforming data so as to easily perform speaker identification. According to the present invention, it is possible to acquire their advantages by mixing acoustic feature transformation matrixes used in each of analysis schemes. Then, the feature transformation unit 33 extracts a row having a large eigenvalue from the acoustic feature transformation matrix according to each of the PCA and the LDA, arranges rows extracted from each of the acoustic feature transformation matrixes, according to the extraction sequence, and combines the row obtained by the PCA with the row obtained by the LDA, thereby reconstructing one acoustic feature transformation matrix, i.e. the above-described hybrid acoustic feature transformation matrix. Then, the feature transformation unit 33 multiplies the acoustic feature with the hybrid acoustic feature transformation matrix, thereby generating a final feature vector.

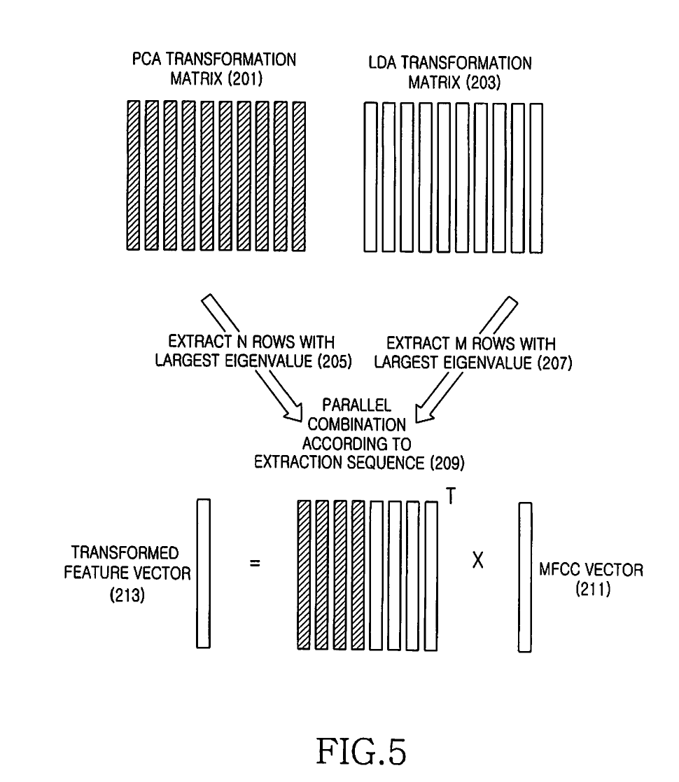

The process for generating such a hybrid acoustic feature transformation matrix is shown in FIG. 5. The feature transformation unit 33 in FIG. 3 extracts n rows having an eigenvalue higher than a predetermined threshold value from the PCA transformation matrix (as indicated by reference numeral 201), which is an acoustic feature transformation matrix according to the PCA (as indicated by reference numeral 205), and extracts m rows having an eigenvalue higher than a predetermined threshold value from the LDA transformation matrix (as indicated by reference numeral 203), which is an acoustic feature transformation matrix according to the LDA (as indicated by reference numeral 207). Then, the feature transformation unit 33 arranges a matrix with n rows and m rows according to the extraction sequence for parallel combination (as indicated by reference numeral 209), and reconstructs a hybrid acoustic feature transformation matrix (T) having dimensionality equal to that of an original acoustic feature transformation matrix. The number of n rows and m rows, i.e. an eigenvalue corresponding to the predetermined threshold value, may vary depending on an environment, and it is possible to acquire an optimal performance through adjustment. Then, the feature transformation unit 33 multiplies the extracted MFCC vector 211 representing an acoustic feature with the hybrid acoustic feature transformation matrix (T) so as to generate the transformed feature vector 213, and outputs the generated vector to the model training unit 36 and the recognition unit 35 in FIG. 3.

The model training unit 36 generates a GMM from the input feature vector so as to generate models of each speaker, and stores the models in the speaker model storage unit 37. Therefore, the model training unit 36 divides each speech text according to a frame, and calculates an MFCC factor corresponding to each frame. It is normal to construct a speaker model by the GMM used for the text-independent speaker verification. When there is a feature vector of a D dimension, the mixture density for a speaker is expressed by Equation (3) below.

$$\begin{matrix}p ( \vec{x} \vert {λ}_{s} ) = {\sum }_{i = 1}^{M} {w}_{i} {b}_{i} ( \vec{x} ) \\ {b}_{i} ( \vec{x} ) = \frac{1}{{( 2 π )}^{D / 2} {\vert Σ \vert}^{1 / 2}} exp ( - \frac{1}{2} {( \vec{x} - {μ}_{i} )}^{T} {( {Σ}_{i} )}^{- 1} ( \vec{x} - {μ}_{i} ) )\end{matrix} \qquad ( 3 )$$

In Equation (3), wᵢ is a mixture weight and bᵢ is a probability resulting from the GMM. The density is a weighted linear combination of M Gaussian mixture models parameterized by a mean vector and a covariance matrix. A weight wᵢ, a mean value μi, and distribution Σi, which are parameters of the GMM, can be estimated by an Expectation-Maximization (EM) algorithm, as shown in Equation (4) below. In Equation (4), λₛ denotes an eigenvalue, and x denotes an eigenvector.

$$\begin{matrix}\begin{matrix}{\hat{w}}_{i} = \frac{1}{T} {\sum }_{i = 1}^{T} p ( i \vert {x}_{t} , {λ}_{s} ) \\ {\hat{μ}}_{i} = \frac{{\sum }_{i = 1}^{T} p ( i \vert {x}_{t} , {λ}_{s} ) {x}_{t}}{{\sum }_{t = 1}^{T} p ( i \vert {x}_{t} , {λ}_{s )}}\end{matrix} \\ {\hat{Σ}}_{i} = \frac{{\sum }_{t = 1}^{T} p ( i \vert {x}_{t} , {λ}_{s} ) {x}_{t}^{2}}{{\sum }_{t = 1}^{T} p ( i \vert {x}_{t} , {λ}_{s} )} - \hat{{μ}_{t}^{2}}\end{matrix} \qquad ( 4 )$$

The speaker model storage unit 37 outputs the speaker model input from the model training unit 36 to the recognition unit 35, and the recognition unit 35 calculates a log-likelihood value of the input speaker model, and then performs the speaker identification. In relation to an input speaker model, the recognition unit 35 looks up a speaker model having the maximum probability as shown in Equation (5) below from the background speaker models stored in advance, thereby finding the speaker.

$$\hat{S} = arg max {\sum }_{t = 1}^{T} log p ( \vec{{x}_{t}} \vert {λ}_{k} ) \qquad ( 5 )$$

In determining if the input speaker model corresponds to a registrant or a non-registrant for speaker verification, the recognition unit 35 uses a difference between the log-likelihood value obtained from the speaker identification and the log-likelihood value obtained from the universal background speaker model. Herein, the input speaker model may be classified as a non-registrant when the difference value is lower than a threshold value, and the input speaker model may be classified as a registrant when the difference value is higher than the threshold value. It is possible to determine the threshold value so that a False Acceptance Rate (FAR) is automatically equal to a False Reject Rate (FRR) by collecting speech registered as a background speaker model and speech resulting from a speaker regarded as an intruder. In this case, when the input speaker model is classified as a non-registrant, for additional information acquisition, classification is performed according to gender distinction and an age bracket, and thus a related-service is provided. When the speaker recognition is achieved by the above-described process, the robot server 30 transmits the result to the robot 10 through the transceiver 31. In receiving the result of the speaker recognition, the robot 10 determines if the robot 10 performs the action corresponding to the speech input by a corresponding speaker, according to the result.

Moreover, in the adaptation step, the recognition unit 35 uses only a maximum of ten percent of scores having high reliability from among score values recognized through the speaker identification during a predetermined period to be adapted to the speech feature varying depending on the passage of time. Parameter values of a Gaussian speaker model are transformed by a Bayesian adaptation scheme, as shown in Equation (6), and it is possible to acquire the adapted speaker model.

$$\begin{matrix}\begin{matrix}\begin{matrix}{n}_{i} = {\sum }_{i = 1}^{T} p ( j \vert \vec{{x}_{t}} ) \\ {E}_{i} ( \vec{x} ) = \frac{1}{{n}_{i}} {\sum }_{i = 1}^{T} p ( j \vert \vec{{x}_{i}} ) \vec{{x}_{t}}\end{matrix} \\ {E}_{i} ( \vec{{x}^{2}} ) = \frac{1}{{n}_{i}} {\sum }_{t = 1}^{T} p ( j \vert \vec{{x}_{t}} ) \vec{{x}_{i}^{2}}\end{matrix} \\ p ( j \vert \vec{{x}_{i}} ) = \frac{{w}_{j} {b}_{j} ( \vec{{x}_{t}} )}{{\sum }_{i = 1}^{M} {w}_{i} {b}_{i} ( \vec{{x}_{t}} )}\end{matrix} \qquad ( 6 )$$

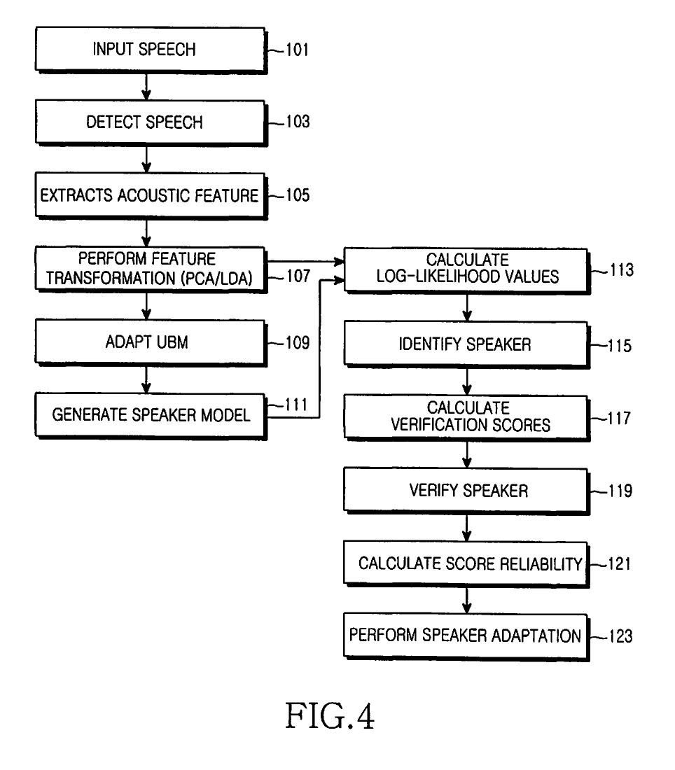

As described above, an operation process for the speaker recognition of the robot 10 and the robot server 30 will be described with reference to FIG. 4. FIG. 4 is a flow chart illustrating a process for speech speaker recognition according to the present invention. When speech is an input in step 101, the robot 10 detects the speech in step 103, and transmits the speech data including the detected speech to the robot server 30. In step 105, the robot server 30 extracts an acoustic feature from the received speech data, and extracts an MFCC matrix. In step 107, the robot server 30 generates an acoustic feature transformation matrix according to each of the PCA and the LDA, extracts a row having the largest eigenvalue from each of acoustic feature transformation matrixes, and arranges rows extracted from each of acoustic feature transformation matrixes according to the extraction sequence for their combination, thereby constructing a hybrid acoustic feature transformation matrix. The robot server 30 generates a final transformation feature vector by multiplying the hybrid acoustic feature transformation matrix with the MFCC matrix. In step 109, the robot server 30 adapts a Universal Background Model (UBM) to the generated feature vector, and generates a GMM. In step 111, it generates a speaker model. In step 113, a log-likelihood value for the feature vectors generated in step 107 and a log-likelihood value for the speaker model generated in step 111 are calculated, and the speaker identification is performed in step 115. The robot server 30 calculates verification scores in step 117, verifies the speaker in step 119, calculates score reliability in step 121, and performs speaker adaptation in step 123.

By applying a speaker recognition scheme according to present invention to a robot system, a robot 10 includes a speech detection unit, and a robot server 30 includes other constructions necessary for speaker recognition. However, the speaker recognition apparatus 40 may also include a speech detection unit. Moreover, the speaker recognition apparatus 40 including a speech detection unit may be included in either a robot 10 or a robot server 30. Otherwise, the speaker recognition apparatus 40 having a speech detection unit may be independently arranged. As described above, the present invention performs speaker recognition through acoustic feature transformation of speech data by extracting some rows from acoustic feature transformation matrixes generated according to each of the PCA and the LDA, arranging the extracted rows according to the extraction sequence to construct a hybrid acoustic feature transformation matrix, and multiplying the hybrid acoustic feature transformation matrix with an acoustic feature to generate a final feature vector. Therefore, it is possible to achieve accurate speaker identification and speaker recognition robust against a noise environment.

While the invention has been shown and described with reference to a certain exemplary embodiment thereof, it will be understood by those skilled in the art that various changes in form and details may be made therein without departing from the spirit and scope of the invention as defined by the appended claims.

What is claimed is:

1. A method for speech speaker recognition using a speech speaker recognition apparatus, the method comprising the steps of:
(1) detecting effective speech data from input speech;
(2) extracting an acoustic feature from the speech data;
(3) generating an acoustic feature transformation matrix from the speech data according to each of Principal Component Analysis (PCA) and Linear Discriminant Analysis (LDA), mixing each of the acoustic feature transformation matrixes to construct a hybrid acoustic feature transformation matrix, and multiplying the matrix representing the acoustic feature with the hybrid acoustic feature transformation matrix to generate a final feature vector; and
(4) generating a speaker model from the final feature vector, comparing a pre-stored universal speaker model with the generated speaker model to identify the speaker, and verifying the identified speaker.

2. The method as claimed in claim 1, wherein step (3) comprises:
generating a PCA acoustic feature transformation matrix from the speech data using the PCA;
generating an LDA acoustic feature transformation matrix from the speech data using the LDA;
extracting rows having an eigenvalue higher than a predetermined threshold value from the PCA acoustic feature transformation matrix;
extracting rows having an eigenvalue higher than a predetermined threshold value from the LDA acoustic feature transformation matrix;
arranging the extracted rows according to an extraction sequence and constructing the hybrid acoustic feature transformation matrix; and
generating the final feature vector by multiplying a Mel Frequency Cepstrum Coefficient (MFCC) matrix representing the acoustic feature with the hybrid acoustic feature transformation matrix.

3. The method as claimed in claim 2, wherein the hybrid acoustic feature transformation matrix has a dimensionality equal to a dimensionality of each of the PCA acoustic feature transformation matrix and the LDA acoustic feature transformation matrix.

4. The method as claimed in claim 3, wherein the speaker model corresponds to a Gaussian Mixture Model (GMM).

5. An apparatus for speech speaker recognition comprising:
a speech detection unit for detecting effective speech data from input speech;
a feature extraction unit for extracting an acoustic feature from the speech data;
a feature transformation unit for generating an acoustic feature transformation matrix from the speech data according to each of Principal Component Analysis (PCA) and Linear Discriminant Analysis (LDA), mixing each of the acoustic feature transformation matrixes to construct a hybrid acoustic feature transformation matrix, and multiplying the matrix representing the acoustic feature with the hybrid acoustic feature transformation matrix to generate a final feature vector; and
a recognition unit for generating a speaker model from the final feature vector, comparing a pre-stored general speaker model with the generated speaker model to identify the speaker, and verifying the identified speaker.

6. The apparatus for speech speaker recognition as claimed in claim 5, wherein the feature transformation unit generates a PCA acoustic feature transformation matrix from the speech data using the PCA, generates an LDA acoustic feature transformation matrix from the speech data using the LDA, extracts rows having an eigenvalue higher than a predetermined threshold value from the PCA acoustic feature transformation matrix, extracts rows having an eigenvalue higher than a predetermined threshold value from the LDA acoustic feature transformation matrix, arranges the extracted rows according to an extraction sequence to construct the hybrid acoustic feature transformation matrix, and generates the final feature vector by multiplying Mel Frequency Cepstrum Coefficient (MFCC) matrix representing the acoustic feature with the hybrid acoustic feature transformation matrix.

7. The apparatus for speech speaker recognition as claimed in claim 6, wherein the hybrid acoustic feature transformation matrix has a dimensionality equal to a dimensionality of each of the PCA acoustic feature transformation matrix and the LDA acoustic feature transformation matrix.

8. The apparatus for speech speaker recognition as claimed in claim 7, wherein the speaker model corresponds to a Gaussian Mixture Model (GMM).
